(19) United States
(12) Patent Application Publication
(10) Pub. No.: US 2023/0223566 A1
(43) Pub. Date: Jul. 13, 2023

(54) PROCESS OF MANUFACTURING A MEMBRANE ELECTRODE ASSEMBLY

(71) Applicant: JOHNSON MATTHEY HYDROGEN TECHNOLOGIES LIMITED, London (GB)

(72) Inventors: Luke HARRISON, Swindon, Wiltshire (GB); Obinna OKAFOR, Swindon, Wiltshire (GB)

(21) Appl. No.: 17/998,302

(22) PCT Filed: Jul. 7, 2021
(86) PCT No.: PCT/GB2021/051726

§ 371 Date: Nov. 9, 2022

(30) Foreign Application Priority Data
Jul. 9, 2020 (GB) 2010522.7

(51) Int. Cl. H01M 8/0284; H01M 8/1004; H01M 8/0276

(52) U.S. Cl. CPC H01M 8/0284; H01M 8/0276; H01M 8/1004; H01M 2008/1095

(57) ABSTRACT

The present invention provides a process of manufacturing a sub-gasketed membrane electrode assembly in which ultrasonic energy is applied to a single face of an intermediate construct to form bonds between the gas diffusion layers and the sub-gaskets.

### FIELD OF THE INVENTION

The present invention relates to a process of manufacturing a sub-gasketed membrane electrode assembly in which the gas diffusion layers are bonded using ultrasonic energy.

### BACKGROUND OF THE INVENTION

A fuel cell is an electrochemical cell comprising two electrodes separated by an electrolyte. A fuel, e.g. hydrogen, an alcohol such as methanol or ethanol, or formic acid, is supplied to the anode and an oxidant, e.g. oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

Fuel cells are usually classified according to the nature of the electrolyte employed. Often the electrolyte is a solid polymeric membrane, in which the membrane is electronically insulating but ionically conducting. In the proton exchange membrane fuel cell the ion-conducting membrane is proton conducting, and protons, produced at the anode, are transported across the ion-conducting membrane to the cathode, where they combine with oxygen to form water.

A principal component of the proton exchange membrane fuel cell is the sub-gasketed membrane electrode assembly, constructed of multiple layers. The central layer is the polymer ion-conducting membrane. On either face of the ion-conducting membrane there is an electrocatalyst layer containing an electrocatalyst designed for the specific electrolytic reaction. This sandwich of ion-conducting membrane and electrocatalyst layers provides an active areas. The electrocatalyst layers also generally comprise a proton conducting material, such as a proton conducting polymer, to aid transfer of protons from the anode electrocatalyst to the ion-conducting membrane and/or from the ion-conducting membrane to the cathode electrocatalyst. Adjacent to each electrocatalyst layer there is a gas diffusion layer. The gas diffusion layer must allow the reactants to reach the electrocatalyst layer and must conduct the electric current that is generated by the electrochemical reactions. Therefore, the gas diffusion layer must be porous and electrically conducting.

Sub-gaskets are present on one or both surfaces of the polymer ion-conducting membrane. The sub-gaskets contain apertures which define the active area of the membrane electrode assembly, and are attached to the ion-conducting membrane or electrocatalyst layers by use of an adhesive. These sub-gaskets are present to prevent gas leakage, and may contain further apertures away from the active area which are aligned in a fuel cell stack to facilitate porting of gases and liquids in the stack. A fuel cell stack can include a large number of sub-gasketed membrane electrode assemblies along with flow field plates which are carefully aligned to avoid, for example, gas leakage, hydrogen crossover and performance deterioration. The overall power of the stack is proportional to the number of such assemblies in a stack. The performance of the stack depends in part on the integrity and various contacts and sealing interfaces within and between adjacent assemblies in the stack.

Conventional processes of manufacturing sub-gasketed membrane electrode assemblies first require manufacturing a sub-gasketed catalyst coated ion-conducting membrane which comprises the polymer ion-conducting membrane disposed between two electrocatalyst layers, with sub-gaskets on both sides of the catalyst coated ion-conducting membrane. This can be manufactured, for example, by a roll-to-roll process in which, firstly, electrocatalyst layers are transferred to respective sides of an ion-conducting membrane by a decal transfer process. Then, in a second roll-to-roll process the two sub-gaskets are applied to the catalyst coated ion-conducting membrane. Gas diffusion layers are then combined with the sub-gasketed catalyst coated ion-conducting membrane over the active areas using an adhesive to bond the gas diffusion layers to the sub-gasketed catalyst coated ion-conducting membrane. The adhesive may be a hot-melt glue and the parts are bonded using heated plates, either in a heated press or a bespoke machine equivalent. This allows the glue to flow and bond the parts together.

However, the sub-gasketed membrane electrode assemblies contain materials, such as the polymer ion-conducting membrane, which are highly sensitive to changes in humidity and temperature. At suboptimal temperature and humidity, the materials shrink or expand, absorbing or rejecting moisture, causing them to change dimensions significantly. This can result in an unstable part with creases, bubbles and waves. The inventors have found that the use of heated plates to melt the glue region may not allow effective control of the heat in the required region and can facilitate these undesirable effects. Such effects can result in sealing issues when the part placed in a fuel cell stack and if a cell in a fuel cell stack fails, the entire system fails.

### SUMMARY OF THE INVENTION

Accordingly, the present invention provides a process of manufacturing a sub-gasketed membrane electrode assembly, said process comprising the steps of:
i) providing a sub-gasketed catalyst coated ion-conducting membrane, wherein the sub-gasketed catalyst coated ion-conducting membrane comprises;
   a) a catalyst coated ion-conducting membrane comprising an ion-conducting membrane disposed between first and second electrocatalyst layers;
   c) a first sub-gasket and a second sub-gasket, each having an aperture defined by inner edges of each respective sub-gasket;
   wherein the catalyst coated ion-conducting membrane is disposed between the first and second sub-gaskets and the first and second electrocatalyst layers are exposed through the apertures of the first and second sub-gaskets respectively to provide first and second active areas respectively;
ii) forming an intermediate construct by applying first and second gas diffusion layers to opposite faces respectively of the sub-gasketed catalyst coated ion-conducting membrane over the apertures in the first and second sub-gaskets respectively such that the first gas diffusion layer overlaps the entire first active area and one or more inner edges of the first sub-gasket, and the second gas diffusion layer overlaps the entire second active area and one or more inner edges of the second sub-gasket; wherein a first adhesive track is provided to bond the first gas diffusion layer to the first sub-gasket and a second adhesive track is provided to bond the second gas diffusion layer to the second sub-gasket;
iii) applying ultrasonic energy to a single face of the intermediate construct from step ii) to flow the adhesive in the first and second adhesive tracks and form the bonds between the first and second gas diffusion layers and the first and second sub-gaskets respectively thus forming the sub-gasketed membrane electrode assembly, wherein the ultrasonic energy is only applied over regions in which the first and second adhesive tracks are present.

The inventors surprisingly found that targeted ultrasonic energy can be successfully used to form a bond between the gas diffusion layers and the sub-gasketed catalyst coated ion-conducting membrane. In particular, it is surprising that both adhesive tracks react equally and both form a bond upon application of ultrasonic energy to a single face. It is advantageous that such targeted ultrasonic energy can be used in the bond forming step because the amount of energy applied to the part can thus be carefully controlled, and reduced, relative to conventional processes. Accordingly, unwanted changes in the materials of the membrane electrode assembly can be minimised. Moreover, the inventors surprisingly found that the use of ultrasonic energy is advantageous because it increases the through-put of the process. For example, bonding does not require relatively long periods, such as ten seconds or more, often required when using heating plates.

### BRIEF DESCRIPTION OF THE DRAWINGS

FIGS. 1a-d are cross-sectional views of sub-gasketed catalyst coated ion-conducting membranes with varying configurations.

FIG. 2a is a cross-sectional view of part of the process of the invention in which first and second gas diffusion layers comprising adhesive tracks are provided.

FIG. 2b is a cross-sectional view of part of the process of the invention in which ultrasonic energy is applied.

FIG. 3 is a cross-sectional optical microscope image of a gas diffusion layer which has been adhered to a sub-gasket by application of ultrasonic energy over an adhesive track.

FIG. 4 is a cross-sectional optical microscope image of a sub-gasketed membrane electrode assembly manufactured by the process of the invention.

### DETAILED DESCRIPTION OF THE INVENTION

Preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

The sub-gasketed membrane electrode assembly manufactured in the process of the invention comprises the sub-gasketed catalyst coated ion-conducting membrane disposed between the first and second gas diffusion layers, wherein the first gas diffusion layer overlaps the entire first active area and one or more inner edges of the first sub-gasket, the second gas diffusion layer overlaps the entire second active area and one or more inner edges of the second sub-gasket, the first gas diffusion layer is bonded to the first sub-gasket by the adhesive in the first adhesive track, and the second gas diffusion layer is bonded to the second sub-gasket by the adhesive in the second adhesive track.

The sub-gasketed catalyst coated ion-conducting membrane electrode assembly provided in step i) of the process can have a number of different configurations, providing that the ion-conducting membrane is disposed between the first and second electrocatalyst layers, and catalyst coated ion-conducting membrane is disposed between the first and second sub-gaskets and the first and second electrocatalyst layers are exposed through the apertures of the first and second sub-gaskets respectively to provide first and second active areas respectively. In particular, the ion-conducting membrane may extend to all of the peripheral edges of the first and second sub-gaskets. Alternatively, the ion-conducting membrane does not extend to one or more peripheral edges of the first and second sub-gaskets. As will be apparent, the ion-conducting membrane overlaps with all of the inner edges of the first and second sub-gaskets. The peripheral edges of the first and second sub-gaskets are the edges which define the shape of the first and second sub-gaskets, different from the inner edges which define the apertures in each sub-gasket. Additionally, the first and second electrocatalyst layers may or may not extend to all of the edges of the ion-conducting membrane. Preferably, the first and second electrocatalyst layers do not extend to any of the edges of the ion-conducting membrane. If the ion-conducting membrane extends to all of the peripheral edges of the first and second sub-gaskets, then the first and second electrocatalyst layers may also extend to all of the peripheral edges of the first and second sub-gaskets, but preferably do not.

In the configuration in which the first and second electrocatalyst layers do not extend to any of the edges of the ion-conducting membrane, the first and second electrocatalyst layers may be disposed within the apertures in the first and second sub-gaskets respectively such that there is no overlap between the first and second electrocatalyst layers and any of the inner edges of the first and second sub-gaskets. Alternatively, the first and second electrocatalyst layers may overlap one or more, preferably all, of the inner edges of the first and second sub-gaskets.

The centre points of the first and second active areas, and accordingly the centre points of the first and second apertures in the first and second sub-gaskets, may be aligned in the through-plane direction. The inner edges of the first and second sub-gaskets which define the first and second apertures may also be aligned in the through-plane direction. The centre points of the first and second electrocatalyst layers may be aligned in the through-plane direction. The edges of the first and second electrocatalyst layers may also be aligned in the through-plane direction. The term “through-plane direction” used herein is the Cartesian z-direction and is aligned with the thickness of the sub-gasketed ion-conducting membrane (and accordingly also the thicknesses of the constructs and assemblies which comprise the sub-gasketed ion-conducting membrane). The two faces referred to herein are perpendicular to the through-plane direction and extend in the Cartesian x, y-directions.

The sub-gasketed catalyst coated ion-conducting membrane provided in step i) is typically provided as a single unit which may have been cut from a roll-good subassembly. Such a roll-good subassembly comprises multiple sub-gasketed catalyst coated ion-conducting membrane units in the form of a continuous catalyst coated ion-conducting membrane web disposed between first and second sub-gasket webs. Such roll-good subassemblies are known in the art as well as processes for manufacturing them. For example, a roll-to-roll transfer processes is employed in which, firstly, continuous electrocatalyst layers are transferred to respective opposite faces of an ion-conducting membrane web by decal transfer using heated rollers. Then, the first and second sub-gasket webs are applied to respective opposite faces of the catalyst coated ion-conducting membrane using heated rollers. The electrocatalyst layers may alternatively be applied to the ion-conducting membrane web in the form of single unit electrocatalyst layers. In which case, the roll-good sub-assembly comprises individualised electrocatalyst layers rather than continuous electrocatalyst layers.

The first and second sub-gaskets are adhered to the catalyst coated ion-conducting membrane using any suitable adhesive, for example, a pressure sensitive adhesive, a heat sensitive adhesive, a UV activated adhesive or otherwise. For example, the adhesive layer may comprise acrylic pressure sensitive adhesives, rubber based adhesives, ethylene maleic anhydride copolymers, olefin adhesives, nitrile based adhesives, epoxy based adhesives, and urethane based adhesives. When the ion-conducting membrane does not extend to the peripheral edges of the first and second sub-gaskets, the regions of the first and second sub-gaskets which extend beyond the edges of the ion-conducting membrane will be adhered.

The first and second sub-gaskets may comprise any material which is compatible with the fuel cell environment. For example, first and second sub-gaskets must be able to withstand temperatures in the range of and including 20 to -180° C. as well as the presence of water, hydrogen and/or oxygen. Suitable materials include polyester, polyimide, polyethylene naphthalate and polyethylene terephthalate. The thickness of the first and second sub-gaskets is not particularly limited but may suitably be in the range of and including 10 to 100 µm. The first and second sub-gaskets are not required to have identical characteristics. For example, the first and second sub-gaskets can have different thicknesses and/or be prepared from different materials. The first and second sub-gaskets may also comprise features which facilitate handling or fuel cell operation. For example, the first and second sub-gaskets may comprise apertures in the region of their respective peripheral edges which do not overlap the first and second active areas. These apertures may, for example, facilitate porting of gases in a fuel cell stack. These apertures may also facilitate handling of the sub-gasketed membrane electrode assemblies. If the ion-conducting membrane extends to all of the peripheral edges of the first and second sub-gaskets, then these apertures will also extend through the ion-conducting membrane and, if applicable, the first and second electrocatalyst layers. The shape of the first and second sub-gaskets is not particularly limited. Put another way, the peripheral edges of the first and second sub-gaskets may define any shape, and this shape is usually determined by the arrangement of parts in a particular fuel cell stack. However, it is preferred that the peripheral edges of the first and second sub-gaskets are aligned in the through-plane direction. It is also preferred that two of the peripheral edges of the first and second sub-gaskets are parallel.

The ion-conducting membrane is preferably any membrane suitable for use in a proton exchange membrane fuel cell or electrolyser. Accordingly, the ion-conducting membrane preferably comprises a proton-conducting polymer, preferably a proton-conducting ionomer. A skilled person understands that an ionomer is a polymer composed of both electrically neutral repeating units and ionizable repeating units covalently bonded to the polymer backbone via side-chains. For example the ion-conducting membrane may be based on a perfluorinated sulphonic acid material such as Nafion® (Chemours Company), Aquivion® (Solvay Specialty Polymers), Flemion® (Asahi Glass Group) and Aciplex® (Asahi Kasei Chemicals Corp.). Alternatively, the ion-conducting membrane may be based on a sulphonated hydrocarbon membrane such as those available from FuMA-Tech GmbH as the fumapem® P, E or K series of products, JSR Corporation, Toyobo Corporation, and others.

The ion-conducting membrane may comprise additional components such as peroxide decomposition catalysts and/or radical decomposition catalysts, and/or recombination catalysts. Recombination catalysts catalyse the recombination of unreacted H₂ and O₂ which can diffuse into the ion-conducting membrane from the anode and cathode of a fuel cell respectively, to produce water. The ion-conducting membrane may also comprise a reinforcement material, such as a planar porous material (for example expanded polytetrafluoroethylene (ePTFE) as described in USRE37307), embedded within the thickness of the ion-conducting membrane, to provide for improved mechanical strength of the ion-conducting membrane, such as increased tear resistance and reduced dimensional change on hydration and dehydration, and thus further increase the durability of a membrane electrode assembly and lifetime of a fuel cell incorporating the catalysed ion-conducting membrane of the invention.

The first and second electrocatalyst layers comprise an electrocatalyst. The exact electrocatalyst used will depend on the reaction it is intended to catalyse, and its selection is within the capability of the skilled person. The electrocatalyst may be a cathode or an anode electrocatalyst, preferably of a fuel cell or an electrolyser, more preferable a proton exchange membrane fuel cell or electrolyser. The electrocatalyst is suitably selected from:
(i) the platinum group metals (platinum, palladium, rhodium, ruthenium, iridium and osmium);
(ii) gold or silver;
(iii) a base metal;
   or an alloy or mixture comprising one or more of these metals or their oxides. A base metal is tin or a transition metal which is not a noble metal. A noble metal is a platinum group metal (platinum, palladium, rhodium, ruthenium, iridium or osmium) or gold. Preferred base metals are copper, cobalt, nickel, zinc, iron, titanium, molybdenum, vanadium, manganese, niobium, tantalum, chromium and tin. Typically, the electrocatalyst comprises a platinum group metal or an alloy of a platinum group metal, preferably with a base metal, preferred base metals as defined above. In particular, the electrocatalyst comprises platinum or an alloy of platinum with a base metal, preferred base metals as defined above, more preferably nickel or cobalt, most preferably nickel. The atomic ratio of platinum to alloying metal is typically in the range of and including 3:1 to 1:3.

If the first electrocatalyst layer is a cathode, then the second will be an anode and vice versa. The characteristics of the electrocatalyst layers, such as the thickness, electrocatalyst loading, porosity, pore size distribution, average pore size and hydrophobicity will depend on whether it is being used at the anode or cathode. In a fuel cell anode, the electrocatalyst layer thickness is suitably at least 1 µm, typically at least 5 µm. In a fuel cell anode, the electrocatalyst layer thickness is suitably no more than 15 µm, typically no more than 10 µm. In a fuel cell cathode, the electrocatalyst layer thickness is suitably at least 2 µm, typically at least 5 µm. In a fuel cell cathode, the electrocatalyst layer thickness is suitably no more than 20 µm, typically no more than 15 µm. The electrocatalyst loading in the electrocatalyst layers will also depend on the intended use. In this context, electrocatalyst loading means the amount of active metal, for example platinum group, in the electrocatalyst layer.

The electrocatalyst layers preferably comprises an ion-conducting polymer, such as a proton-conducting ionomer, to improve the ion-conductivity of the layer. Accordingly, the ion-conducting material may include ionomers such as perfluorosulphonic acid materials (e.g. Nafion® (Chemours Company), Aciplex® (Asahi Kasei), Aquivion® (Solvay Specialty Polymer), Flemion® (Asahi Glass Co.) and perfluorosulphonic acid ionomer material supplied by 3M®), or ionomers based on partially fluorinated or non-fluorinated hydrocarbons that are sulphonated or phosphonated polymers, such as those available from FuMA-Tech GmbH as the fumapem® P, E or K series of products, JSR Corporation, Toyobo Corporation, and others. Suitably, the ionomer is a perfluorosulphonic acid, in particular the Nafion® range available from Chemours company, especially Nafion® 1100EW, and the Aquivion ® range available from Solvay, especially Solvay® 830EW.

The electrocatalyst layers may comprise additional components. Such components include, but are not limited to: an oxygen evolution catalyst; a hydrogen peroxide decomposition catalyst; a hydrophobic additive (e.g. a polymer such as polytetrafluoroethylene (PTFE) or an inorganic solid with or without surface treatment) or a hydrophilic additive to control reactant and water transport characteristics. The choice of additional components will depend on whether the electrocatalyst layer is for use at the anode or the cathode and it is within the capability of a skilled person to determine which additional components are appropriate.

The first and second gas diffusion layers comprise a gas diffusion substrate and, preferably, a microporous layer. Typical gas diffusion substrates include non-woven papers or webs comprising a network of carbon fibres and a thermoset resin binder (e.g. the TGP-H series of carbon fibre paper available from Toray Industries Inc., Japan or the H2315 series available from Freudenberg FCCT KG, Germany, or the Sigracet® series available from SGL Technologies GmbH, Germany or AvCarb® series from Ballard Power Systems Inc.), or woven carbon cloths. The carbon paper, web or cloth may be provided with a pretreatment prior to fabrication of the electrode and being incorporated into a membrane electrode assembly either to make it more wettable (hydrophilic) or more wet-proofed (hydrophobic). The nature of any treatments will depend on the type of fuel cell and the operating conditions that will be used. The substrate can be made more wettable by incorporation of materials such as amorphous carbon blacks via impregnation from liquid suspensions, or can be made more hydrophobic by impregnating the pore structure of the substrate with a colloidal suspension of a polymer such as PTFE or polyfluoroethylenepropylene (FEP), followed by drying and heating above the melting point of the polymer. Typical microporous layers comprise a mixture of a carbon black and a polymer such as polytetrafluoroethylene (PTFE).

The first and second gas diffusion layers overlap the entire first and second active areas respectively of the sub-gasketed membrane electrode assembly. The first gas diffusion layer preferably overlaps all of the inner edges of the first sub-gasket around the aperture in the first sub-gasket, and the second gas diffusion layer preferably overlaps all of the inner edges of the second sub-gasket around the aperture in the second sub-gasket. The first and second gas diffusion layers preferably do not extend to the peripheral edges of the first and second sub-gaskets respectively. The centre points of the first and second gas diffusion layers may be aligned in the through-plane direction. Also, the edges of the first and second gas diffusion layers may be aligned in the through-plane direction.

The first and second gas diffusion layers are applied as individual units which may, for example, be cut from a roll, which cutting may be performed by hand or in an automated process. A skilled person will be aware of ways in which the first and second gas diffusion layers can be applied to the sub-gasketed catalyst coated ion-conducting membrane. For example, the unitised gas diffusion layers may be transferred to the sub-gasketed catalyst coated ion-conducting membrane manually or by an atomised robot arm which may use, for example, vacuum suction to pick up and place the gas diffusion layer. The first and second gas diffusion layers may be applied substantially concurrently, or they may be applied sequentially. For example, addition of the first and second gas diffusion layers may be facilitated by the use of a jig.

The first and second adhesive tracks provided in step ii) of the process may each independently comprise continuous (i.e. unbroken) or discontinuous (i.e. broken) adhesive. The adhesive is preferably discontinuous, preferably in the form of beads of adhesive. Such beads are preferably equally spaced. Both tracks comprise an adhesive that can be processed to form a bond, e.g. softens and flows, upon application of ultrasonic energy. Both the first and second adhesive tracks preferably comprise the same adhesive. Ultrasonic energy may be defined as mechanical oscillations between 15 kHz and 50 KHz. The adhesive may comprise any melt processable thermoplastic adhesive. For example, a hot melt adhesive such as a hot melt plastic adhesive, specifically polymer adhesive. Suitably, the adhesive is a polyolefin adhesive e.g. a polymer of a simple olefin such as a CₙH₂ₙ olefin such as propylene or ethylene. The adhesive may also be a poly-α-olephin. The adhesive may also be a hot melt adhesive based on polymers and copolymers of ethyl vinyl acetate (EVA), PVC, PVA, polystyrene, polyester, polyacrylate, polyamide and polyurethane. The adhesive is preferably a hot melt polyolefin adhesive. Specific materials include, for example, those from the Technomelt Surpa® range from Henkel® including Technomelt Supra® 100 Cool which provides 1,000 to 1,5000 mPas viscosity at 100° C. and a setting point of 80 to 90° C.; Technomelt Supra® 150 Cool from Henkel® which provides 2100-2600 mPas viscosity at 160° C. and has a softening point of 96 to 106° C. The first adhesive track may be provided by applying adhesive directly to the first sub-gasket and the second adhesive track may be provided by applying adhesive directly to the second sub-gasket. Also, the first adhesive track may be provided by applying adhesive directly to the first gas diffusion layer and the second adhesive track may be provided by applying adhesive directly to the second gas diffusion layer. Preferably, the first adhesive track is applied to the first gas diffusion layer and the second adhesive track is applied to the second gas diffusion layer. The first and second adhesive tracks at least partially surround the apertures in the first and second sub-gaskets respectively, preferably fully surround the apertures in the first and second sub-gaskets respectively such that the first and second adhesive tracks frame the first and second active areas. Preferably, the first and second adhesive tracks are superimposed. Put another way, the first and second adhesive tracks are aligned in the through-plane direction. The distance between the inner edges of the of the first and second sub-gaskets and the first and second adhesive tracks respectively is not particularly limited and is dependent on, for example, the degree of overlap between the first and second gas diffusion layers and the first and second sub-gaskets respectively, and the desired dimensions of the part being produced. The width of the first and second adhesive tracks is not particularly limited and can be, for example, in the range of and including 0.5 to 3.0 mm. In the case in which the tracks comprise beads of adhesive, this width corresponds with the average diameter of the beads.

The application of ultrasonic energy causes the adhesive to flow into the gas diffusion layer whilst remaining in contact with the sub-gasket, which facilitates formation of the bond between the first and second gas diffusion layers and the first and second sub-gaskets respectively. Put another way, the ultrasonic energy causes the adhesive to melt and impregnate the gas diffusion layer. If a microporous layer is present in the gas diffusion layer then it is preferable that the adhesive flows into the microporous layer and does not pass into the gas diffusion substrate. However, some adhesive may flow into the gas diffusion substrate. Preferably the adhesive flows into the gas diffusion substrate to a maximum distance of no more than 75% thickness of the gas diffusion substrate, preferably no more than 50% thickness of the gas diffusion substrate, more preferably no more than 25% thickness of the gas diffusion substrate (for avoidance of doubt this does not include the thickness of the microporous layer). The distance that the adhesive flows into the gas diffusion substrate is not necessarily uniform, and the maximum flow distance may, for example, be the peak of an arc of adhesive which has flowed into the gas diffusion substrate. The maximum flow distance may be controlled by, for example, the pressure applied during the application of ultrasonic energy and the time period over which ultrasonic energy is applied. It is a surprising advantage of the present invention that the adhesive tracks on both faces of the assembly will form a bond between the sub-gaskets and the gas diffusion layers with application of ultrasonic energy only to a single face. Moreover, it is advantageous that, in the case in which there is a defect in a microporous layer which allows adhesive to flow freely into the gas diffusion substrate, the flow distance can be controlled. Too much adhesive in the gas diffusion substrate can cause problems with compression of the gas diffusion substrate, for example, in a fuel cell stack.

Ultrasonic energy is preferably applied using a sonotrode, otherwise known as a horn, operating at a frequency suitably in the range of and including 15 to 50 KHz and an amplitude suitably in the range of and including 0.01 to 4.0 mm. A generator produces electrical oscillations at the desired frequency, which are then transferred to a converter in which crystals expand and contract creating mechanical vibrations at the same frequency. These vibrations are transferred to the sonotrode which, in the present invention, is brought into contact with a single face of the intermediate construct. Accordingly, the ultrasonic energy is applied to a single face of the intermediate construct preferably by contacting a sonotrode with a single face of the intermediate construct, suitably the first or second gas diffusion layer. To apply the ultrasonic energy over the regions of the intermediate construct in which the adhesive tracks are present, the sonotrode follows the path of the adhesive tracks. Put another way, the sonotrode follows a path on the first or second gas diffusion layer which is aligned in the through-plane direction with the adhesive tracks.

The intermediate construct is supported during application of ultrasonic energy by, for example, placing the opposite face on a horizontally level surface, i.e. a base plate, which acts as an anvil. Accordingly, the applied pressure is controlled by controlling the distance between the level surface, i.e. base plate, and the tip of the sonotrode, hereafter the gap. The required gap is dependent on the thickness of the materials used and may generally be, for example, in the range of and including 0.05 to 0.7 mm. The energy required may depend, for example, on the particular adhesive used and is proportional to the time period during which ultrasonic energy is applied. Generally, the amount of energy imputed may be, for example, in the range of and including 350 to 2000 J. Typically, ultrasonic energy is applied for a time of at least 0.1 seconds and suitably no more than 5 seconds, suitably no more than 2 seconds, preferably no more than 1 second. The relatively short period of time required for bonding is advantageous because it speeds up the process for manufacturing sub-gasketed membrane electrode assemblies. The step of adding gas diffusion layers and forming bonds is often a bottle neck in the manufacture of sub-gasketed membrane electrode assemblies.

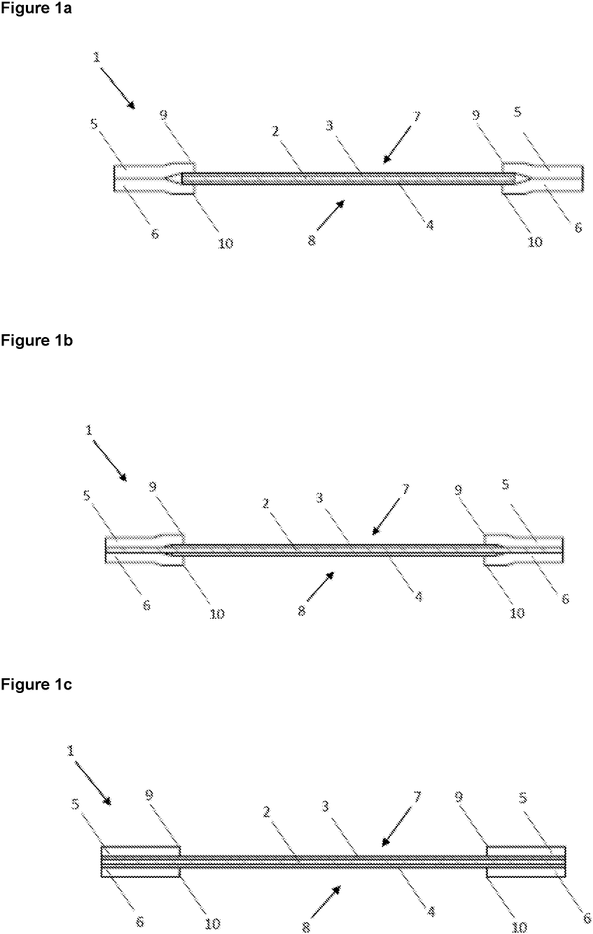

Turning to the drawings, FIG. 1a provides a cross-sectional view of a sub-gasketed catalyst coated ion-conducting membrane 1 which includes ion-conducting membrane 2, first and second electrocatalyst layers 3 and 4 and first and second sub-gaskets 5 and 6. In this particular sub-gasketed catalyst coated ion-conducting membrane, from the viewpoint shown, the ion-conducting membrane 2 and the electrocatalyst layers 3 and 4 are co-terminus and do not extend to the illustrated peripheral edges of the first and second sub-gaskets 5 and 6. Apertures 7 and 8 are defined by inner edges 9 and 10 of the first and second sub-gaskets 5 and 6 providing the active areas of the sub-gasketed catalyst coated ion-conducting membrane. FIG. 1b is a sub-gasketed catalyst coated ion-conducting membrane in which, from the viewpoint shown, the ion-conducting membrane 2 extends to the illustrated peripheral edges of the first and second sub-gaskets 5 and 6 but the first and second electrocatalyst layers 3 and 4 do not. FIG. 1c is a sub-gasketed catalyst coated ion-conducting membrane in which, from the viewpoint shown, both the ion-conducting membrane 2 and the first and second electrocatalyst layers 3 and 4 extend to the illustrated peripheral edges of the first and second sub-gaskets 5 and 6. FIG. 1d is a sub-gasketed catalyst coated ion-conducting membrane in which, from the viewpoint shown, the ion-conducting membrane extends to the illustrated peripheral edges of the first and second sub-gaskets 5 and 6, but the first and second electrocatalyst layers 3 and 4 are disposed within the apertures 7 and 8 in the first and second sub-gaskets 5 and 6 and do not overlap any of the inner edges of the first and second sub-gaskets 5 and 6.

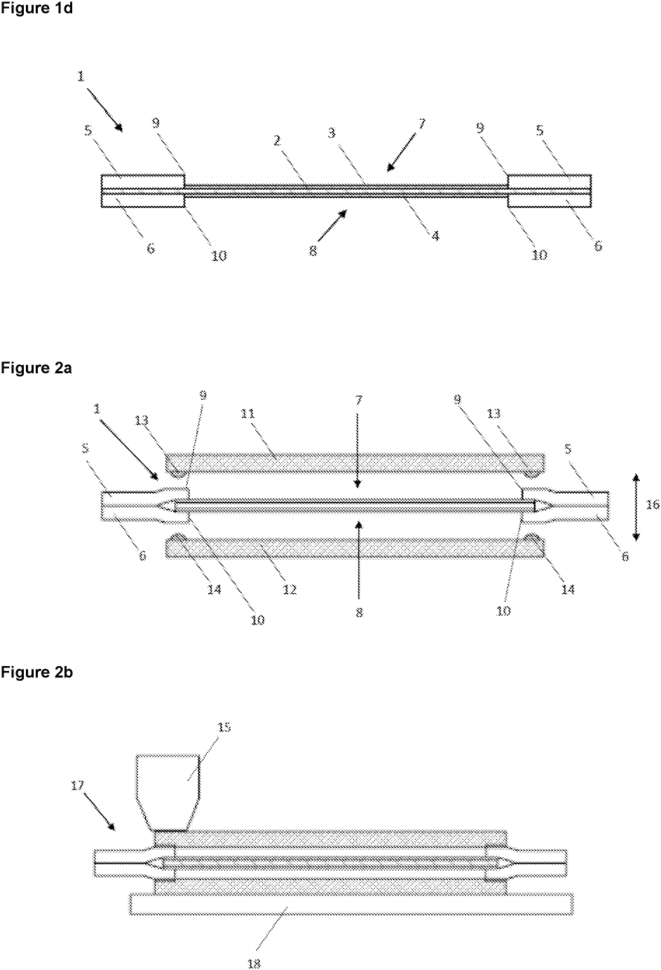

FIG. 2a shows first and second gas diffusion layers 11 and 12 positioned adjacent to opposite faces of a sub-gasketed catalyst coated ion-conducting membrane 1 having the same cross-sectional configuration as shown in FIG. 1a. First and second adhesive tracks 13 and 14, which are formed from beads of a melt processable polyolefin adhesive, are present on first and second gas diffusion layers 11 and 12 respectively and follow the edges of the gas diffusion layers 11 and 12 and also the inner edges 9 and 10 of the first and second sub-gaskets. The first and second gas diffusion layers 11 and 12, the first and second adhesive tracks 13 and 14 and the apertures 7 and 8 are aligned in the through-plane direction 16. The first and second gas diffusion layers 11 and 12 are applied to the first and second sub-gaskets 5 and 6 to provide an intermediate construct 17 as shown in FIG. 2b. Ultrasonic energy is applied by contacting sonotrode 15 with first gas diffusion layer 11 and moving the sonotrode 15 over the areas which comprise adhesive tracks 13 and 14, whilst the assembly is on base plate (anvil) 18, thus forming the sub-gasketed membrane electrode assembly.

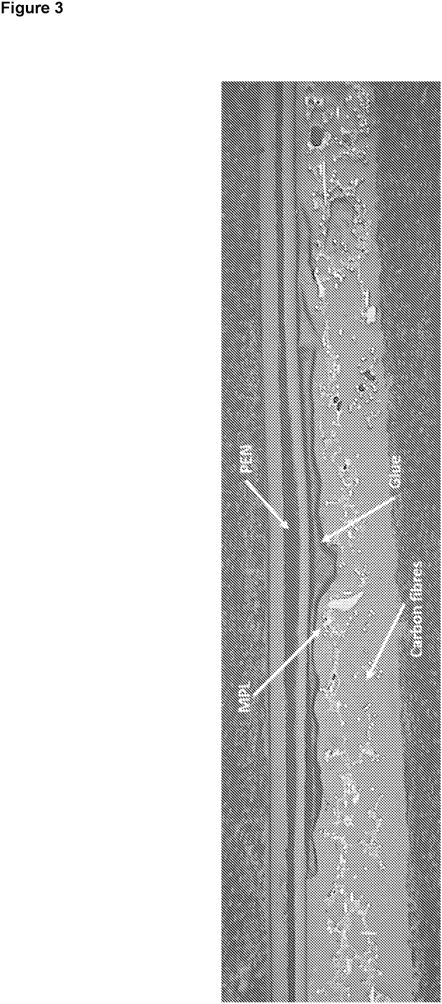

FIG. 3 shows an example in which a single Avcarb® MB30 gas diffusion layer (GDL) comprising carbon fibres and a microporous layer (MPL) was adhered to a polyethylene naphthalate (PEN) sub-gasket with hot melt polyolefin adhesive Technomelt® Supra 100 Cool from Henkel®. The GDL was cut to the correct size using a kiss cutter. This GDL was then placed in jig that allowed the perimeter of the GDL to have discrete beads of the hot melt polyolefin adhesive applied to it. The GDL was then placed in a jig with the sub-gasket. Once in position, ultrasonic energy was applied to the GDL to form a bond between the sub-gasket and the GDL using an Xfurth® 20 kHz benchtop machine with an applied pressure of 1 bar. 700 J were applied over five seconds. As can be seen in FIG. 3, the adhesive remains in contact with the sub-gasket, and penetrates into the MPL and partially into the GDL but not so far as to create compression issues in the GDL.

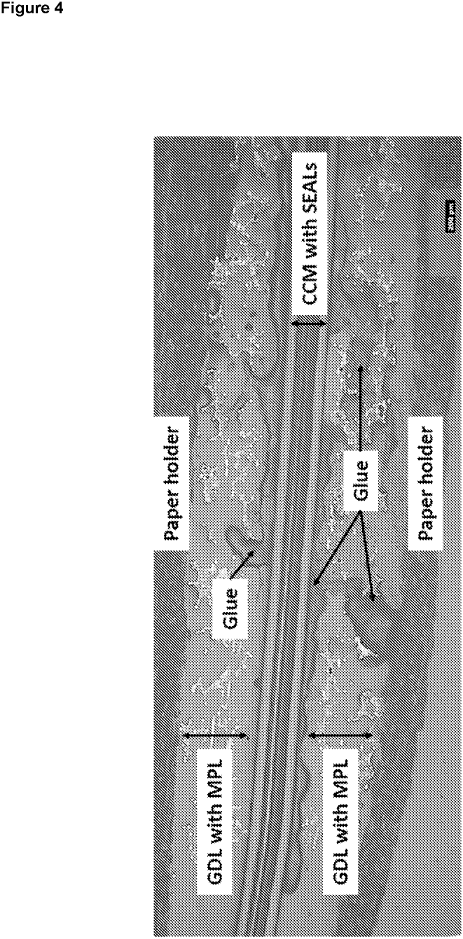

FIG. 4 shows an example of a sub-gasketed membrane electrode assembly manufactured in accordance with the invention using two Avcarb® MB30 GDLs each comprising carbon fibres and a MPL, and 25 µm thick PEN first and second sub-gaskets adhered to a catalyst coated membrane (CCM). The GDLs were cut to the correct size using a kiss cutter. The GDLs were then placed in jig that allowed the perimeters of the GDLs to have discrete beads of hot melt polyolefin adhesive Technomelt® Supra 100 Cool from Henkel® applied to them. Once the two pieces of GDL were glue beaded they were placed in a jig either side of the CCM, the purpose of the jig being to ensure that the GDLs were correctly aligned with the CCM and each other. Once in position on a base plate (anvil) the ultrasonic energy was applied to a single face of the assembly to form the bonds between the sub-gaskets and the GDLs using an Xfurth® 20 kHz benchtop machine with an applied pressure of 1 bar and a hard stop gap set to a minim of 0.6 mm between the horn and the anvil. 560J of total energy was applied over four seconds. As can be seen in FIG. 4, the adhesive on both sides remains in contact with the sub-gaskets, and penetrates the GDLs. Some adhesive has penetrated across the lower GDL due to a defect in the MPL, but not to the extent that it will cause compression problems for the GDL.

To prepare the cross sections shown in the figures, samples of the area of interest are taken (2.5 cm by 1.5 cm, with the longer dimension being the aspect that will be viewed). These samples are then mounted vertically in a paper holder that separates multiple samples from each other. The paper holder containing the samples is then placed into a plastic mould of diameter 2.6 cm with the target face at the bottom, after coating the mould in a release agent. A cold curing epoxy resin (EpoxyCure 2, Buehler®) is then poured over the sample to cover it completely. The mould is then placed into a vacuum chamber and the pressure reduced to 0.3 bar in order to help remove air trapped into the sample. Once this is complete the mould is transferred into a pressure vessel and put under a pressure of 80 psi till the resin is cured (24 h).

After 24 h the mould is removed from the pressure vessel and the resin is removed from the mould. The target surface of the resin in then polished using a Buehler® AutoMet Grinder-Polisher in successive stages ending with Buehler® MasterPrep Polishing Suspension 0.05 µm. This gives the sample a smooth surface allowing the cross section to be clearly imaged using an optical microscope. Successive polishing operations can be used to move the cross section down through the sample.

1-17. (canceled)

18. A process of manufacturing a sub-gasketed membrane electrode assembly, said process comprising the steps of:
i) providing a sub-gasketed catalyst coated ion-conducting membrane, wherein the sub-gasketed catalyst coated ion-conducting membrane comprises;
a) a catalyst coated ion-conducting membrane comprising an ion-conducting membrane disposed between first and second electrocatalyst layers;
c) a first sub-gasket and a second sub-gasket, each having an aperture defined by inner edges of each respective sub-gasket;
wherein the catalyst coated ion-conducting membrane is disposed between the first and second sub-gaskets and the first and second electrocatalyst layers are exposed through the apertures of the first and second sub-gaskets respectively to provide first and second active areas respectively;
ii) forming an intermediate construct by applying first and second gas diffusion layers to opposite faces respectively of the sub-gasketed catalyst coated ion-conducting membrane over the apertures in the first and second sub-gaskets respectively such that the first gas diffusion layer overlaps the entire first active area and one or more inner edges of the first sub-gasket, and the second gas diffusion layer overlaps the entire second active area and one or more inner edges of the second sub-gasket;
wherein a first adhesive track is provided to bond the first gas diffusion layer to the first sub-gasket and a second adhesive track is provided to bond the second gas diffusion layer to the second sub-gasket;
iii) applying ultrasonic energy to a single face of the intermediate construct from step ii) to flow the adhesive in the first and second adhesive tracks and form the bonds between the first and second gas diffusion layers and the first and second sub-gaskets respectively thus forming the sub-gasketed membrane electrode assembly, wherein the ultrasonic energy is only applied over regions in which the first and second adhesive tracks are present.

19. The process according to claim 18, wherein in step iii) the ultrasonic energy is applied by contacting a sonotrode with the first or second gas diffusion layer, wherein the sonotrode follows a path on the first or second gas diffusion layer, wherein the path is aligned in the through-plane direction with the first and second adhesive tracks.

20. The process according to claim 18, wherein in step iii) the intermediate construct is supported on a horizontally level surface present on the opposite face to which the ultrasonic energy is applied.

21. The process according to claim 18, wherein the adhesive in the first and second adhesive tracks is a hot melt polyolefin adhesive.

22. The process according to claim 18, wherein in step i) the sub-gasketed catalyst coated ion-conducting membrane is provided as a single unit.

23. The process according to claim 1, wherein the first adhesive track is provided by applying the adhesive directly to the first sub-gasket.

24. The process according to claim 18, wherein the second adhesive track is provided by applying the adhesive directly to the second sub-gasket.

25. The process according to claim 18, wherein the first adhesive track is provided by applying the adhesive directly to the first gas diffusion layer.

26. The process according to claim 18, wherein the second adhesive track is provided by applying the adhesive directly to the second gas diffusion layer.

27. The process according to claim 18, wherein the first adhesive track fully surrounds the aperture in the first sub-gasket.

28. The process according to claim 18, wherein the second adhesive track fully surrounds the aperture in the second sub-gasket.

29. The process according to claim 18, wherein the first and second adhesive tracks comprises beads of adhesive.

30. The process according to claim 18, wherein pressure is applied to the sub-gasketed membrane electrode during step iii).

31. The process according to claim 18, where the ion-conducting membrane does not extend to one or more peripheral edges of the first and second sub-gaskets.

32. The process according to claim 18, wherein the ion-conducting membrane extends to all of the peripheral edges of the first and second sub-gaskets.

33. The process according to claim 18, wherein the first and second electrocatalyst layers are disposed within the apertures in the first and second sub-gaskets respectively and do not overlap any of the inner edges of the first and second sub-gaskets.

34. The process according to claim 18, wherein the first and second electrocatalyst layers do not extend to one or more peripheral edges of the first and second sub-gaskets respectively.
